(19) United States
(12) Patent Application Publication
(10) Pub. No.: US 2024/0012701 A1
(43) Pub. Date: Jan. 11, 2024

(54) STATISTICAL SIGNIFICANCE OF ERRORS OR INSIGHTS

(71) Applicant: Content Square SAS, Paris (FR)

(72) Inventors: Karin Gamus, Paris (FR); Hui Wang, Paris (FR); Corentin Flacher, Paris (FR)

(21) Appl. No.: 18/219,402

(22) Filed: Jul. 7, 2023

Related U.S. Application Data
(60) Provisional application No. 63/359,585, filed on Jul. 8, 2022.

(51) Int. Cl. G06F 11/00; H04L 67/50

(52) U.S. Cl. CPC G06F 11/008; H04L 67/535

(57) ABSTRACT

Method starts with a processor receiving from client devices user activity data associated with interactions by a plurality of users with a website displayed on the client devices and identifying, based on the user activity data, errors associated with the website. Processor determines first error that is statistically significant by determining that a number of sessions from the plurality of sessions including first error and not including first error are greater than a minimum number of sessions threshold. Processor generates a test statistics value associated with first error based on the number of sessions not including first error, the number of sessions including the first error, an error free conversion rate, and an error conversion rate. Processor identifies first error as being statistically significant when test statistic value is greater than test statistic threshold; and causes a user interface including first error to be displayed. Other embodiments are described herein.

### CLAIM OF PRIORITY

This application claims the benefit of priority of U.S. Provisional Application No. 63/359,585, filed Jul. 8, 2022, which is hereby incorporated by reference in its entirety.

### BACKGROUND

Electronic commerce (e-commerce) facilitates trillions of dollars in transactions yearly. Using their personal electronic devices, users can quickly and easily access a business' website or mobile application to purchase goods or services directly from the business.

It is imperative to understand the online customers' digital behaviors and gather insights therefrom. For example, the digital behaviors can include the navigational patterns of the user to the website or within the website as well as interactions with the elements displayed on the website. Improving the online customers' digital experience on the website will directly lead to increased sales and revenue growth from website or mobile application.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some nonlimiting examples are illustrated in the figures of the accompanying drawings in which:

FIG. 1 is a diagrammatic representation of a networked environment in which the present disclosure may be deployed, in accordance with some examples.

FIG. 2 is a diagrammatic representation of an experience analytics system, in accordance with some examples, that has both client-side and server-side functionality.

FIG. 3 is a diagrammatic representation of a data structure as maintained in a database, in accordance with some examples.

FIG. 4 is a flowchart for a process of determining the statistical significance of an error, in accordance with some examples.

FIG. 5 illustrates an example user interface in accordance with one embodiment.

FIG. 6 illustrates an example user interface in accordance with one embodiment.

FIG. 7 is a diagrammatic representation of a machine in the form of a computer system within which a set of instructions may be executed for causing the machine to perform any one or more of the methodologies discussed herein, in accordance with some examples.

FIG. 8 is a block diagram showing a software architecture within which examples may be implemented.

### DETAILED DESCRIPTION

To understand the online customers' digital behaviors, the online customer's digital interactions on the webpage needs to be tracked and analyzed. Among other things, embodiments of the present disclosure improve the functionality of digital experience tracking systems by identifying errors within a user's web site, determining whether these errors are statistically significant, and displaying to the user's playback device the errors that are deemed to be statistically significant. As further discussed below, a statistical significance test is used to identify the errors on the user's web site that are causing a significant loss of conversion to the user (e.g., loss of customers, loss of revenue, etc.). By surfacing the errors that are statistically significant, a business associated with the user can quickly identify the specific errors or causes of friction or frustration within their web site that need to be promptly addressed to minimize the loss of conversions. Similarly, other embodiments can generate insights from the user's website (e.g., rage clicking on a link) and determine whether the insights are statistically significant such that they are to be reported to the user (e.g., displayed on the user's playback device).

### Networked Computing Environment

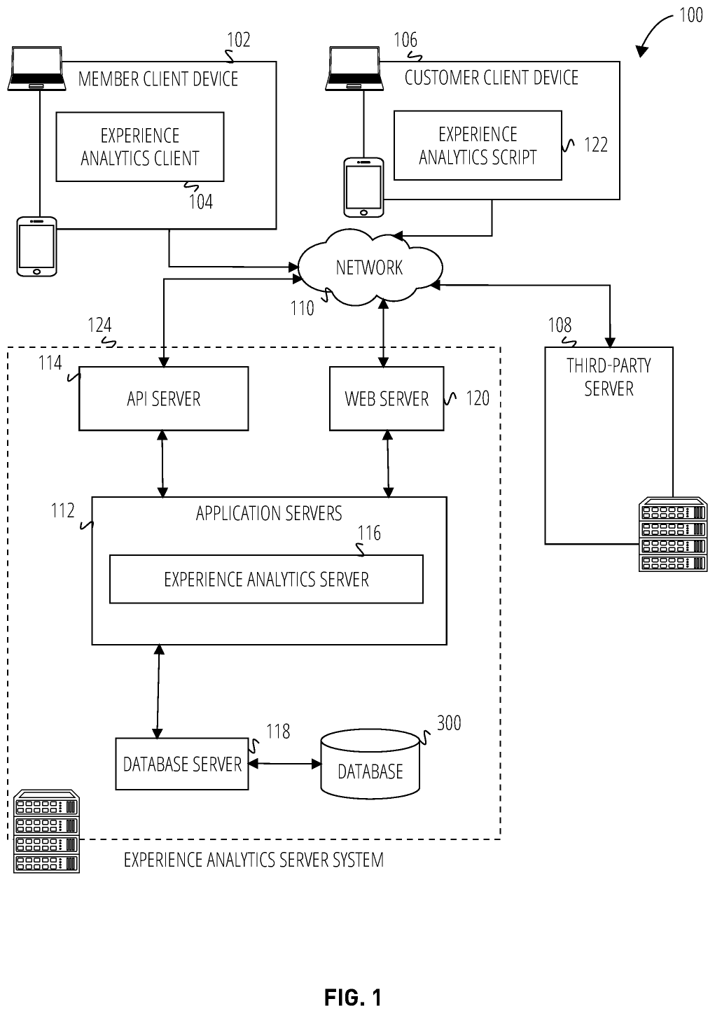

FIG. 1 is a block diagram showing an example experience analytics system 100 that analyzes and quantifies the user experience of users navigating a client's website, mobile websites, and applications. The experience analytics system 100 can include multiple instances of a member client device 102, multiple instances of a customer client device 106, and multiple instances of a third-party server 108.

The member client device 102 is associated with a client of the experience analytics system 100, where the client that has a website hosted on the client's third-party server 108. For example, the client can be a retail store that has an online retail website that is hosted on a third-party server 108. An agent of the client (e.g., a web administrator, an employee, etc.) can be the user of the member client device 102.

Each of the member client devices 102 hosts a number of applications, including an experience analytics client 104. Each experience analytics client 104 is communicatively coupled with an experience analytics server system 124 and third-party servers 108 via a network 110 (e.g., the Internet). An experience analytics client 104 can also communicate with locally-hosted applications using Applications Program Interfaces (APIs).

The member client devices 102 and the customer client devices 106 can also host a number of applications including Internet browsing applications (e.g., Chrome, Safari, etc.). The experience analytics client 104 can also be implemented as a platform that is accessed by the member client device 102 via an Internet browsing application or implemented as an extension on the Internet browsing application.

Users of the customer client device 106 can access client's websites that are hosted on the third-party servers 108 via the network 110 using the Internet browsing applications. For example, the users of the customer client device 106 can navigate to a client's online retail website to purchase goods or services from the website. While the user of the customer client device 106 is navigating the client's website on an Internet browsing application, the Internet browsing application on the customer client device 106 can also execute a client-side script (e.g., JavaScript (.*js)) such as an experience analytics script 122. In one example, the experience analytics script 122 is hosted on the third-party server 108 with the client's website and processed by the Internet browsing application on the customer client device 106. The experience analytics script 122 can incorporate a scripting language (e.g., a .*js file or a .json file).

In certain examples, a client's native application (e.g., ANDROID™ or IOS™ Application) is downloaded on the customer client device 106. In this example, the client's native application including the experience analytics script 122 is programmed in JavaScript leveraging a Software Development Kit (SDK) provided by the experience analytics server system 124. The SDK includes Application Programming Interfaces (APIs) with functions that can be called or invoked by the client's native application.

In one example, the experience analytics script 122 records data including the changes in the interface of the website being displayed on the customer client device 106, the elements on the website being displayed or visible on the interface of the customer client device 106, the text inputs by the user into the website, a movement of a mouse (or touchpad or touch screen) cursor and mouse (or touchpad or touch screen) clicks on the interface of the website, etc. The experience analytics script 122 transmits the data to experience analytics server system 124 via the network 110. In another example, the experience analytics script 122 transmits the data to the third-party server 108 and the data can be transmitted from the third-party server 108 to the experience analytics server system 124 via the network 110.

An experience analytics client 104 is able to communicate and exchange data with the experience analytics server system 124 via the network 110. The data exchanged between the experience analytics client 104 and the experience analytics server system 124, includes functions (e.g., commands to invoke functions) as well as payload data (e.g., website data, texts reporting errors, insights, merchandising information, adaptability information, images, graphs providing visualizations of experience analytics, session replay videos, zoning and overlays to be applied on the website, etc.).

The experience analytics server system 124 supports various services and operations that are provided to the experience analytics client 104. Such operations include transmitting data to and receiving data from the experience analytics client 104. Data exchanges to and from the experience analytics server system 124 are invoked and controlled through functions available via user interfaces (UIs) of the experience analytics client 104.

The experience analytics server system 124 provides server-side functionality via the network 110 to a particular experience analytics client 104. While certain functions of the experience analytics system 100 are described herein as being performed by either an experience analytics client 104 or by the experience analytics server system 124, the location of certain functionality either within the experience analytics client 104 or the experience analytics server system 124 may be a design choice. For example, it may be technically preferable to initially deploy certain technology and functionality within the experience analytics server system 124 but to later migrate this technology and functionality to the experience analytics client 104 where a member client device 102 has sufficient processing capacity.

Turning now specifically to the experience analytics server system 124, an Application Program Interface (API) server 114 is coupled to, and provides a programmatic interface to, application servers 112. The application servers 112 are communicatively coupled to a database server 118, which facilitates access to a database 300 that stores data associated with experience analytics processed by the application servers 112. While shown as a single database 300 in FIG. 1, it is understood that a plurality of databases of various storage types can be used or any combination thereof. Similarly, a web server 120 is coupled to the application servers 112, and provides web-based interfaces to the application servers 112. To this end, the web server 120 processes incoming network requests over the Hypertext Transfer Protocol (HTTP) and several other related protocols.

The Application Program Interface (API) server 114 receives and transmits message data (e.g., commands and message payloads) between the member client device 102 and the application servers 112. Specifically, the Application Program Interface (API) server 114 provides a set of interfaces (e.g., routines and protocols) that can be called or queried by the experience analytics client 104 or the experience analytics script 122 in order to invoke functionality of the application servers 112. The Application Program Interface (API) server 114 exposes to the experience analytics client 104 various functions supported by the application servers 112, including generating information on errors, insights, merchandising information, adaptability information, images, graphs providing visualizations of experience analytics, session replay videos, zoning and overlays to be applied on the website, etc.

The application servers 112 host a number of server applications and subsystems, including for example an experience analytics server 116. The experience analytics server 116 implements a number of data processing technologies and functions, particularly related to the aggregation and other processing of data including the changes in the interface of the website being displayed on the customer client device 106, the elements on the website being displayed or visible on the interface of the customer client device 106, the text inputs by the user into the website, a movement of a mouse (or touchpad) cursor and mouse (or touchpad) clicks on the interface of the website, etc. received from multiple instances of the experience analytics script 122 on customer client devices 106. The experience analytics server 116 implements processing technologies and functions, related to generating user interfaces including information on errors, insights, merchandising information, adaptability information, images, graphs providing visualizations of experience analytics, session replay videos, zoning and overlays to be applied on the website, etc. Other processor and memory intensive processing of data may also be performed server-side by the experience analytics server 116, in view of the hardware requirements for such processing.

### System Architecture

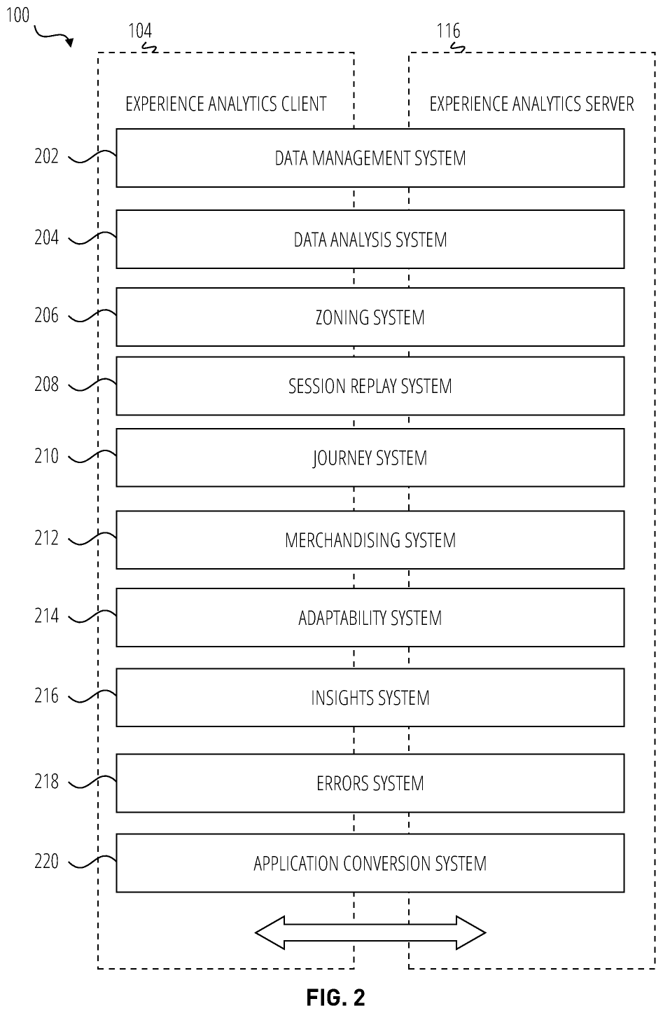

FIG. 2 is a block diagram illustrating further details regarding the experience analytics system 100 according to some examples. Specifically, the experience analytics system 100 is shown to comprise the experience analytics client 104 and the experience analytics server 116. The experience analytics system 100 embodies a number of subsystems, which are supported on the client-side by the experience analytics client 104 and on the server-side by the experience analytics server 116. These subsystems include, for example, a data management system 202, a data analysis system 204, a zoning system 206, a session replay system 208, a journey system 210, a merchandising system 212, an adaptability system 214, an insights system 216, an errors system 218, and an application conversion system 220.

The data management system 202 is responsible for receiving functions or data from the member client devices 102, the experience analytics script 122 executed by each of the customer client devices 106, and the third-party servers 108. The data management system 202 is also responsible for exporting data to the member client devices 102 or the third-party servers 108 or between the systems in the experience analytics system 100. The data management system 202 is also configured to manage the third-party integration of the functionalities of experience analytics system 100.

The data analysis system 204 is responsible for analyzing the data received by the data management system 202, generating data tags, performing data science and data engineering processes on the data.

The zoning system 206 is responsible for generating a zoning interface to be displayed by the member client device 102 via the experience analytics client 104. The zoning interface provides a visualization of how the users via the customer client devices 106 interact with each element on the client's website. The zoning interface can also provide an aggregated view of in-page behaviors by the users via the customer client device 106 (e.g., clicks, scrolls, navigation). The zoning interface can also provide a side-by-side view of different versions of the client's website for the client's analysis. For example, the zoning system 206 can identify the zones in a client's website that are associated with a particular element in displayed on the website (e.g., an icon, a text link, etc.). Each zone can be a portion of the website being displayed. The zoning interface can include a view of the client's website. The zoning system 206 can generate an overlay including data pertaining to each of the zones to be overlaid on the view of the client's website. The data in the overlay can include, for example, the number of views or clicks associated with each zone of the client's website within a period of time, which can be established by the user of the member client device 102. In one example, the data can be generated using information from the data analysis system 204.

The session replay system 208 is responsible for generating the session replay interface to be displayed by the member client device 102 via the experience analytics client 104. The session replay interface includes a session replay that is a video reconstructing an individual user's session (e.g., visitor session) on the client's website. The user's session starts when the user arrives into the client's website and ends upon the user's exit from the client's website. A user's session when visiting the client's website on a customer client device 106 can be reconstructed from the data received from the user's experience analytics script 122 on customer client devices 106. The session replay interface can also include the session replays of a number of different visitor sessions to the client's website within a period of time (e.g., a week, a month, a quarter, etc.). The session replay interface allows the client via the member client device 102 to select and view each of the session replays. In one example, the session replay interface can also include an identification of events (e.g., failed conversions, angry customers, errors in the website, recommendations or insights) that are displayed and allow the user to navigate to the part in the session replay corresponding to the events such that the client can view and analyze the event.

The journey system 210 is responsible for generating the journey interface to be displayed by the member client device 102 via the experience analytics client 104. The journey interface includes a visualization of how the visitors progress through the client's website, page-by-page, from entry onto the website to the exit (e.g., in a session). The journey interface can include a visualization that provides a customer journey mapping (e.g., sunburst visualization). This visualization aggregates the data from all of the visitors (e.g., users on different customer client devices 106) to the website and illustrates the visited pages in the order in which the pages were visited. The client viewing the journey interface on the member client device 102 can identify anomalies such as looping behaviors and unexpected drop-offs. The client viewing the journey interface can also assess the reverse journeys (e.g., pages visitors viewed before arriving at a particular page). The journey interface also allows the client to select a specific segment of the visitors to be displayed in the visualization of the customer journey.

The merchandising system 212 is responsible for generating the merchandising interface to be displayed by the member client device 102 via the experience analytics client 104. The merchandising interface includes merchandising analysis that provides the client with analytics on: the merchandise to be promoted on the website, optimization of sales performance, the items in the client's product catalog on a granular level, competitor pricing, etc. The merchandising interface can, for example, comprise graphical data visualization pertaining to product opportunities, category, brand performance, etc. For instance, the merchandising interface can include the analytics on conversions (e.g., sales, revenue) associated with a placement or zone in the client website.

The adaptability system 214 is responsible for creating accessible digital experiences for the client's web site to be displayed by the customer client devices 106 for users that would benefit from an accessibility-enhanced version of the client's website. For instance, the adaptability system 214 can improve the digital experience for users with disabilities, such as visual impairments, cognitive disorders, dyslexia, and age-related needs. The adaptability system 214 can, with proper user permissions, analyze the data from the experience analytics script 122 to determine whether an accessibility-enhanced version of the client's website is needed, and can generate the accessibility-enhanced version of the client's website to be displayed by the customer client device 106.

The insights system 216 is responsible for analyzing the data from the data management system 202 and the data analysis system 204 surface insights that include opportunities as well as issues that are related to the client's website. The insights can also include alerts that notify the client of deviations from a client's normal business metrics. The insights can be displayed by the member client devices 102 via the experience analytics client 104 on a dashboard of a user interface, as a pop-up element, as a separate panel, etc. In this example, the insights system 216 is responsible for generating an insights interface to be displayed by the member client device 102 via the experience analytics client 104. In another example, the insights can be incorporated in another interface such as the zoning interface, the session replay, the journey interface, or the merchandising interface to be displayed by the member client device 102.

In an embodiment, the insights system 216 can generate a set of metrics referred to herein as insight metrics based on analyzing the data received by the data management system 202 and the analysis from the data analysis system 204. In an example, such insight metrics may indicate insights such as, but not limited to, slow loading time for a webpage(s), hesitation or decisiveness, friction (i.e., whether the portion is contributing to premature terminations of interactions), unusual behavior (e.g., abnormal speed of interactions as compared to previous interactions by users such as rage clicks indicating very abrupt succession of clicking), and the like, with respect to a field or e-form. In an embodiment, the data analysis system 204 identifies one or more friction-causing fields (i.e., fields associated with users becoming frustrated and increasing likelihood of premature termination) based on the insight metrics.

In an example where a given webpage on a retail website includes an e-form that contains different fields for user input or text entry, metrics based on the insight metrics serve as the basis for demonstrating insights related to user interactions with each field as determined based on the data received by the data management system 202. Other example insight metrics may include, but are not limited to, friction scores (i.e., scores indicating a degree of difficulty experienced by users), impact on motivation to share (IMS) scores, behavioral quality scores, cues of deception scores, technological savviness scores, hesitation scores, decisiveness scores, trust scores, trustworthiness scores, frustration scores, carefulness scores, search scores, login scores, emotion scores, sentiment scores, and confusion scores. As a non-limiting example, long average pause times coupled with terminations shortly thereafter may result in a high friction score for a field, suggesting that users encountering that field become frustrated and quit. As another non-limiting example, short average pause and total typing times may result in high trustworthiness scores, suggesting that users interacting with the field were providing honest and accurate information.

The errors system 218 is responsible for analyzing the data from the data management system 202 and the data analysis system 204 to identify errors that are affecting the visitors to the client's website and the impact of the errors on the client's business (e.g., revenue loss). The errors can include the location within the user journey in the website and the page that adversely affects (e.g., causes frustration for) the users (e.g., users on customer client devices 106 visiting the client's website). The errors can also include causes of looping behaviors by the users, in-page issues such as unresponsive calls to action and slow loading pages, etc. The errors can be displayed by the member client devices 102 via the experience analytics client 104 on a dashboard of a user interface, as a pop-up element, as a separate panel, etc. In this example, the errors system 218 is responsible for generating an errors interface to be displayed by the member client device 102 via the experience analytics client 104. In another example, the insights can be incorporated in another interface such as the zoning interface, the session replay, the journey interface, or the merchandising interface to be displayed by the member client device 102.

The application conversion system 220 is responsible for the conversion of the functionalities of the experience analytics server 116 as provided to a client's website to a client's native mobile applications. For instance, the application conversion system 220 generates the mobile application version of the zoning interface, the session replay, the journey interface, the merchandising interface, the insights interface, and the errors interface to be displayed by the member client device 102 via the experience analytics client 104. The application conversion system 220 generates an accessibility-enhanced version of the client's mobile application to be displayed by the customer client devices 106.

### Data Architecture

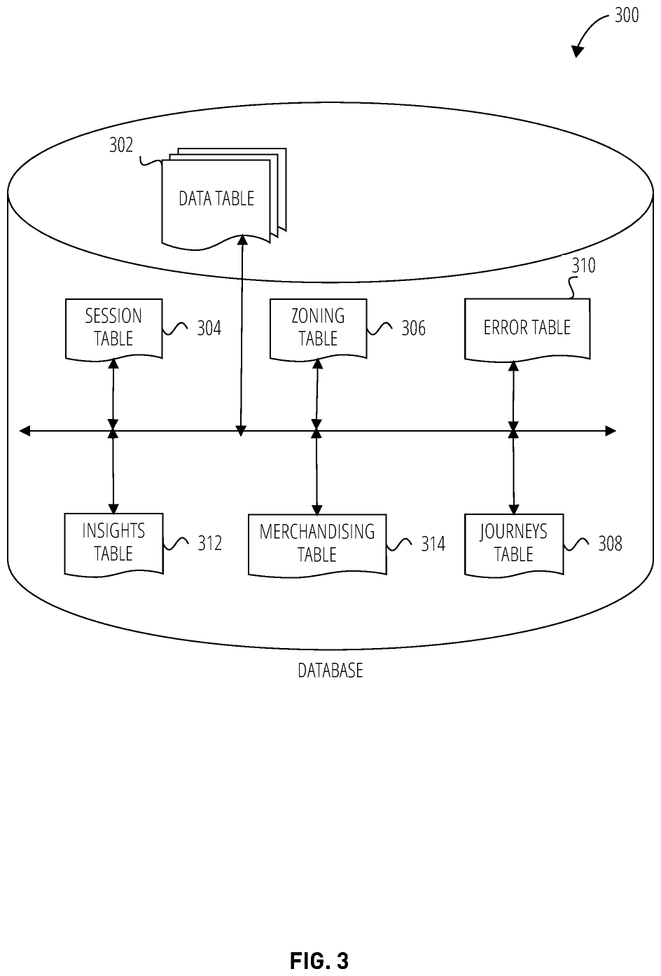

FIG. 3 is a schematic diagram illustrating database 300, which may be stored in the database 300 of the experience analytics server 116, according to certain examples. While the content of the database 300 is shown to comprise a number of tables, it will be appreciated that the data could be stored in other types of data structures (e.g., as an object-oriented database). Further, while FIG. 3 shows as a single database 300, it is understood that a plurality of databases of various storage types can be used or any combination thereof.

The database 300 includes a data table 302, a session table 304, a zoning table 306, an error table 310, an insights table 312, a merchandising table 314, and a journeys table 308.

The data table 302 stores data regarding the websites and native applications associated with the clients of the experience analytics system 100. The data table 302 can store information on the contents of the website or the native application, the changes in the interface of the web site being displayed on the customer client device 106, the elements on the web site being displayed or visible on the interface of the customer client device 106, the text inputs by the user into the website, a movement of a mouse (or touchpad or touch screen) cursor and mouse (or touchpad or touch screen) clicks on the interface of the website, etc. The data table 302 can also store data tags and results of data science and data engineering processes on the data. The data table 302 can also store information such as the font, the images, the videos, the native scripts in the website or applications, etc.

The session table 304 stores session replays for each of the client's websites and native applications.

The zoning table 306 stores data related to the zoning for each of the client's websites and native applications including the zones to be created and the zoning overlay associated with the websites and native applications.

The journeys table 308 stores data related to the journey of each visitor to the client's website or through the native application.

The error table 310 stores data related to the errors generated by the errors system 218 and the insights table 312 stores data related to the insights generated by the insights table 312. In an embodiment, the error table 310 includes data in connection with determining 1) conversion adjustment threshold estimation to estimate a percentage of problematic sessions that can be saved based on benchmark data, 2) conversions opportunity estimation to estimate a number of lost or won conversions, and 3) revenue opportunity estimation to estimate a revenue impact in currency. The error table 310 can also include data related to the confidence critical value (e.g., 99%).

The merchandising table 314 stores data associated with the merchandising system 212. For example, the data in the merchandising table 314 can include the product catalog for each of the clients, information on the competitors of each of the clients, the data associated with the products on the websites and applications, the analytics on the product opportunities and the performance of the products based on the zones in the web site or application, etc.

### Process of Determining Statistical Significance

Although the described flowcharts can show operations as a sequential process, many of the operations can be performed in parallel or concurrently. In addition, the order of the operations may be re-arranged. A process is terminated when its operations are completed. A process may correspond to a method, a procedure, an algorithm, etc. The operations of methods may be performed in whole or in part, may be performed in conjunction with some or all of the operations in other methods, and may be performed by any number of different systems, such as the systems described herein, or any portion thereof, such as a processor included in any of the systems.

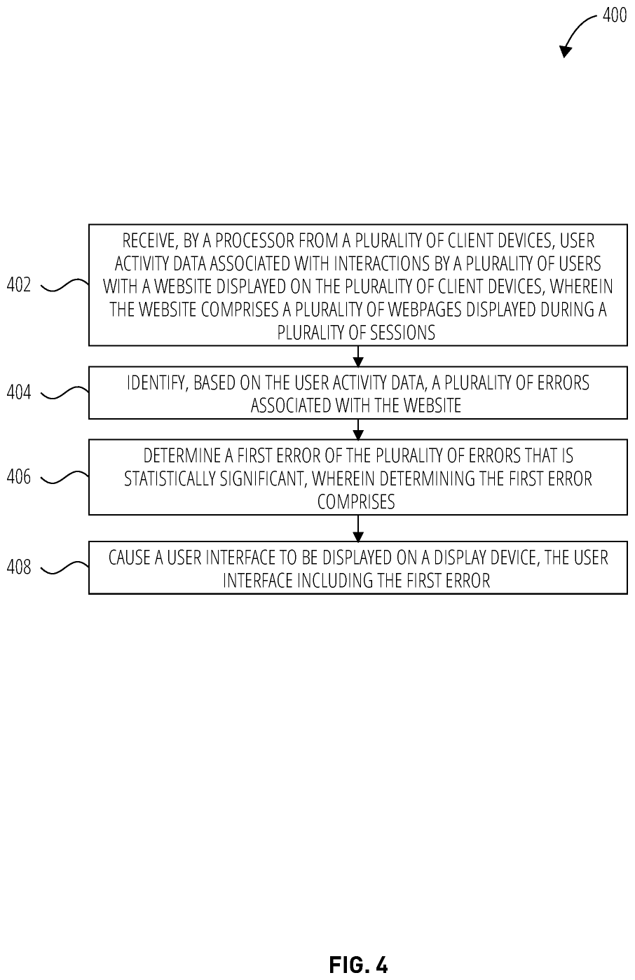

FIG. 4 is a flowchart for a process 400 of determining the statistical significance of an error, in accordance with some examples. For example, the process 400 can be performed by a processor in the errors system 218, in the insights system 216, in any system in the experience analytics system 100, or any combination thereof.

In operation 402, the processor receives from a plurality of client devices, user activity data associated with interactions by a plurality of users with a website displayed on the plurality of client devices. For example, the user activity data comprises changes in an interface of the website displayed on the plurality of client devices, elements on the website displayed or visible on the interface displayed on the plurality of client devices, text inputs by the users into the website displayed on the plurality of client devices, a movement of cursor of a mouse, touchpad or touch screen, a click or activation of the mouse, the touchpad or the touch screen on the interface of the website, or any combination thereof.

The website can comprise a plurality of webpages displayed during a plurality of sessions. Each of the plurality of sessions comprises a timeframe between an entry by a user of the plurality of users into the website and an exit by the user from the website. For example, a session can start when a user enters a web site and can end when the user exits the website.

In operation 404, the processor identifies, based on the user activity data, a plurality of errors associated with the website. For example, the processor can identify experience indicators associated with an error that can comprise the processor detecting a rage click comprising a predetermined number of repeated clicks in less than a minimum threshold of time, detecting a predetermined number of repeated interactions with an element, a field, or a button displayed on the webpages, detecting no clicks on one of the plurality of webpages displayed, detecting that a cursor is hovering more than a predetermined number of times over an element of one of the plurality of webpages, detecting an error is displayed during the session, detecting that the error is displayed after a click, detecting a loading time that exceeds a predetermined amount of time, or any combination thereof.

While a plurality of errors can be identified by the processor in operation 404, it is important to determine the statistical significance of the errors in order to determine which ones are to be surfaced to the user on the playback device. A successful conversion of a customer on the website can be measured in different ways based on website. For example, a successful conversion can include: a completed purchase on the retail website, a completed sign-up for an account on banking institution's website, a completed application for an organization, etc. A conversion rate can be based on the number of successful conversions on the website. In this example, the successful conversions are based on a completed purchase on the website, a completed sign-up for an account on the website, a completed application on the website, or any combination thereof.

The errors encountered on the website can negatively affect the conversion rate for the customers on the web site. For example, a customer on the webpage the encounters a non-functional text box to enter his credit card in the check-out cart of a retail website may not convert (e.g., purchase the item). However, in order to determine whether the conversion rate associated with an error is statistically significant, a statistical significance test is used that is based on the number of sessions encountering the error, the number of sessions not encountering the error, the conversion rate of those encountering the error, the conversion rate of those not encountering the error, etc.

In operation 406, the processor determines a first error of the plurality of errors that is statistically significant. In one example, the processor determines the first error by determining that a number of sessions from the plurality of sessions including the first error and a number of sessions from the plurality of sessions not including the first error is greater than a minimum number of sessions threshold.

In one example, the minimum number of sessions threshold can be set to 30 sessions. Accordingly, the error is not statistically significant if there are not at least 30 sessions including the error and 30 sessions not including the error for testing.

In one example, the processor also determines that the error is not statistically significant if a conversion rate of users in the number of sessions not including the first error (e.g., error free conversion rate) is not greater than a conversion rate of users in the number of sessions including the first error (e.g., an error conversion rate). In other words, if the users are converting at a higher rate when they encounter the error than the error is not statistically significant.

To determine the first error, the processor can further generate a test statistics value associated with the first error based on the number of sessions not including the first error, the number of sessions including the first error, an error free conversion rate that is a conversion rate of sessions not including the first error, and an error conversion rate that is a conversion rate of sessions including the first error.

For example, the processor can generate the test statistics value (e.g., Test Statistics) using the following equation:

$$TestStatistics = \frac{{CR}_{NF} - {CR}_{F}}{\sqrt{{CR}_{T} ( 1 - {CR}_{T} ) ( \frac{1}{{N}_{NF}} + \frac{1}{{N}_{F}} ) )}}$$

In the equation above, the values include:
CR_{NF}: Error free conversion rate which is a conversion rate of the sessions that did not encounter the friction of the first error.
CR_{F}: Error conversion rate which is a conversion rate of the sessions that encountered the friction of the first error.
CR_{T}: Total conversion rate of the sessions that encountered the friction of the first error and the did not encounter the friction of the first error (e.g., CR_{T}=CR_{NF}+CR_{F})
N_{NF}: number of sessions that did not encounter the friction of the first error
N_{F}: number of sessions that encountered the friction of the first error

The processor can identify the first error as being statistically significant when the test statistic value is greater than a test statistic threshold. For example, the test statistic threshold can be based on the confidence critical value (e.g., 99%). To establish a 99% confidence critical value, for example, the test statistic threshold can be set to 2.575.

At operation 408, the processor causes a user interface to be displayed on a display device, the user interface including the first error. For example, the member client device can comprise the display device such that the viewer of the display device is an agent of the client (e.g., a web administrator, an employee, etc.). The member client device 102 can also separate but coupled to the display device.

In one example, the user interface further includes an indication that the first error is statistically significant, the difference in conversion rate caused associated with the first error, the number of sessions associated with the first error, the number of sessions not including the first error, or any combination thereof. In another example, the processor can cause a user interface to be displayed that includes a plurality of errors that the processor has determined is statistically significant.

In one example, the processor can generate the visualization of interactions by one of the users with the website based on the user activity data associated with the one of the users. For example, the user interface can show at least one session replay that is associated with the first error in order to view and identify the web site elements that are causing frictions and the loss of conversion. The processor can generate the visualization of interactions by one of the users with the website based on the user activity data associated with the one of the users. The user interface can also include a selectable element (e.g., link, text, icon, image) that can be selected by a viewer of the display device to cause the at least one session replay to be viewed. The processor can identify the pages in the webpage that are associated with the first error.

### Example: Using the Statistical Significance Test in a Revenue Opportunity Analysis

Embodiments of the subject technology analyze the behavior of anonymous users to generate various metrics (e.g., insights) on a retail web site to assess how such metrics can impact different objectives (e.g., e-commerce conversions, revenue, etc.). For example, quantifying the business impact (e.g., conversion rates, revenue, etc.) of various metrics derived from such user behavior enables the subject technology to determine which type of work (e.g., modifications to the retail website, etc.) to prioritize on the retail website.

In some examples, an impact quantification for the retail website is based on revenue won or lost because business decisions are mostly taken in terms of an amount of money that such decision will bring (or lose) for the retail website. Some existing analytics systems fail to provide such assessments in terms of revenue gained or lost, and how various decisions impact the business. In view of the above, embodiments of the subject technology can identify a revenue opportunity (e.g., increasing revenue) on a given retail website to facilitate improvements in selecting tasks to perform on the web site.

In one example, the insights system 216 perform operations to enable an automated estimation process for determining revenue opportunity on a given retail website. In an implementation, insights system 216 receives a given insight metric(s) and information related thereto (e.g., related metadata providing additional context to the insight metric) from data analysis system 204 and performs automated revenue opportunity estimation through the following stages:
(1) conversion adjustment threshold estimation to estimate a percentage of problematic sessions that can be saved based on benchmark data
(2) conversions opportunity estimation to estimate a number of lost or won conversions
(3) revenue opportunity estimation to estimate a revenue impact in currency

In an example, after performing the three stages, insights system 216 can provide a set of values corresponding to key performance indicator (KPI) values which is discussed further below.

The following discussion relates to the aforementioned three stages beginning with determining the conversation adjustment threshold.

In an example, a conversion adjustment threshold is a percentage (%) of problematic sessions that can really be saved (e.g., moved to conversion by the end of the session). For instance, for an insight metric related to loading time of a webpage, it can be unrealistic to conclude that 100% of the sessions with a high loading time can be saved (e.g., resulting in a conversion) by improving the website performance because for some of these sessions, the high loading time are a result of a poor connection and not the website performance.

In an implementation, an approach utilized by insights system 216 is to estimate this percentage by using benchmark data and thus claim that if the website was doing as good as its industry it should have the same proportion of problematic sessions: the difference with the industry is then our estimation. In an example, benchmark data includes metrics (e.g., average values related to loading time, traffic, session, new users, pages, bounce rate, and the like) that can be compared from other websites, particularly those in the same industry as the retail website in which the insights system 216 is determining the conversion adjustment threshold.

In an embodiment, insights system 216 initiates determining a conversion adjustment threshold after receiving an insight metric(s). In a first operation, insights system 216 determines a percentage of website problematic sessions. In a second operation, insights system 216 determines an average percentage of problematic sessions for this type of insight. In a third operation, insights system 216 determines a difference that represents an estimation of problematic sessions that can be saved. In a fourth operation, insights system 216 determines a conversion adjustment threshold that represents a percentage of problematic sessions that can be saved if improvements are implemented.

In an implementation, determining a conversion adjustment threshold can be performed by the following mathematical notation:

$$Conversions Adjustment Threshold = \frac{\begin{matrix}( \% of prob sessions on website A - \\ \% of prob sessions in industry )\end{matrix}}{\% of prob sessions on website A}$$

In the second stage, insights system 216 determines a conversions opportunity estimation. In an example, the conversions opportunity is the number of conversions (e.g., sessions that converted) that are estimated to have been lost or won based on a particular insight metric.

In an embodiment, insights system 216 initiates determining a conversions opportunity estimation after receiving an insight metric(s). In a first operation, insights system 216 determines a bad segment corresponding to a set of problematic sessions, and determines a good segment corresponding to a set of non-problematic sessions. In a second operation, insights system 216 determines a conversion rate difference to define if a friction is negatively affecting the sessions to reach a given goal. Here, a statistical significance test can be performed in connection with determining the conversion rate difference. In a third operation, insights system 216 determines a conversions opportunity estimation based on a number of won/lost conversions, which is based on the conversion adjustment threshold from the first stage discussed above.

In an implementation, insights system 216 utilizes an estimation approach based on correlation: if a higher conversion rate is observed on a good segment, then it is implied that a bad segment underperformed because of the insight metric.

Thus, the conversions opportunity estimation is based on a strong hypothesis: the insight metric is the only difference of behavior between the 2 segments (e.g., the good segment and the bad segment). If this holds, then the insight metric is determined to be the cause.

This, however, can lead to a risk. As only a sample of data (the data of the selected period) is observed, insights system 216 can determine a direction error: a client can be informed that an insight metric negatively affected the conversion rate while in reality this was not statistically significant. The risk here is that the client implements an AB test that provides flat or negative results or that the client implements a fix in production and ultimately loses money while insights system 216 was informing the client to the contrary.

To mitigate this risk, insights system 216 performs a statistical significance test, which is discussed further below. It is good to notice that this statistical test does not remove fully the risk-if the above stated hypothesis does not hold then everything is biased.

In an implementation, insights system 216 determines a conversions opportunity based on the following mathematical notation, where CR stands for conversion rate:

Conversions Opportunity=Problematic sessions×Conversion Adjustment Threshold×(CR_{non problematic}−CR_{problematic})

In an embodiment, insights system 216 initiates determining a conversion adjustment threshold after receiving an insight metric(s). In a first operation, insights system 216 determines a percentage of website problematic sessions. In a second operation, insights system 216 determines an average percentage of problematic sessions for this type of insight. In a third operation, insights system 216 determines a difference that represents an estimation of problematic sessions that can be saved. In a fourth operation, insights system 216 determines a conversion adjustment threshold that represents a percentage of problematic sessions that can be saved if improvements are implemented.

In the third stage, insights system 216 determines a revenue opportunity estimation.

In an embodiment, insights system 216 initiates determining a revenue opportunity estimation after receiving an insight metric(s). In a first operation, insights system 216 receives the conversions opportunity estimation which is determined in the second stage discussed above. In a second operation, insights system 216 determines a median revenue for the retail website based on actual generated revenues and determining a median value from that, which also performed outlier removal from the actual generated revenues. In a third operation, insights system 216 determines the revenue opportunity estimation based on the median revenue.

In an implementation, the revenue opportunity is the amount of money that the retail website has lost or won because of a particular insight metric, and can heavily rely on the previous conversions opportunity estimation from the second stage.

During this step another risk appears. As only a sample of data (the data of the selected period) is observed, insights system 216 determines a magnitude error: if in a given period there are only 2 sessions that bought an amount of $10,000 (while normally $100 is purchased on this website) then these outliers will bias revenues data to be more important than what they should be. The risk therefore is that insights system 216 may inform a client that they could gain $5,000 while in reality only $500 will be gained.

To handle this error and risk, insights system 216 remove outliers in the purchasing amounts by taking the median revenue and not the average revenue at the retail website.

In an implementation, determining a revenue opportunity estimation can be performed by the following mathematical notation:

Conversions Opportunity×Median Cart_{non problematic}

The following discussion relates to lost/won revenue computations, which are implemented and utilized by insights system 216 to at least determine the revenue opportunity estimation described above.

In the following discussion, two segments are utilized: 1) Segment S will be the segment selected by a client in insights system 216, and 2) Segment C will be the segment of comparison (depending on a product decision, this segment can be inputted by the client, or it can be an all visitors segment, or all visitors minus the sessions of segment S).

In an embodiment, insights system 216 determines 1) value(s) for lost/won conversions, and 2) value(s) for lost/won revenues. The following discussion relates to how these values are determined.

Insights system 216 utilizes the following input values to determine value(s) for lost/won conversions:
conversionsS=Number of sessions from Segment S that converted
conversionsC=Number of sessions from Segment C that converted
totalSessionsS=Total sessions from Segment S
totalSessionsC=Total sessions from Segment C

Insights system 216 utilizes the following operations to determine various values, as represented by the following:
Conversion Rates of Segment S and Segment C
   CR_{S}=conversionsS/totalSessionsS
   CR_{C}=conversionsC/totalSessionsC
Conversion Rate Total
   CR_{T}=(conversionsS+conversionsC)/(totalSessionsS+totalSessionsC)
Conversion Rate Difference
   CRDiff=CR_{S}−CR_{C}

In an implementation, as discussed above, a statistical significance test can be represented by the following mathematical notation, where CR stands for conversion rate:

$$testStatistics = abs ( \frac{CRDiff}{\sqrt{{CR}_{T} ( 1 - {CR}_{T} ) ( \frac{1}{totalSessionS} + \frac{1}{totalSessionC} )}} )$$

With respect to the above equation, the following can apply:
testStatisticsThreshold=2.575 (corresponds to 99% confidence level for a 2-tailed test)
statisticalSignificanceTest=
   IF testStatistics>testStatisticsThreshold
   AND totalSessionsS>30
   AND totalSessionsC>30
THEN 1 (there is statistical significance)
ELSE 0 (there is no statistical significance)

Insights system 216 utilizes the following operations to determine conversions opportunity estimation, as represented by the following:
conversionsOpportunity=
   IF statisticalSignificanceTest=1
   THEN totalSessionsS×(CR_{S}−CR_{C})
   ELSE 0

In view of the above, in an example, suppose statisticalSignificanceTest=1 indicating there is statistical significance:
If totalSessionsS×(CRS−CRC)<0 then it means that insights system 216 handles Lost Conversions
If totalSessionsS×(CRS−CRC)>0 then it means that insights system 216 handles Won Conversions

The following discussion relates to determining lost/won revenues as mentioned before.

Insights system 216 utilizes the following input values to determine value(s) for lost/won revenues:
conversionsOpportunity=Number of lost or won conversions (see above)
medianCartS=Median revenue of the buying sessions from Segment S
medianCartC=Median revenue of the buying sessions from Segment C

Insights system 216 utilizes the following operations to determine various values, as represented by the following:
Revenue Opportunity revenueOpportunity=
   IF conversionsOpportunity<0 (this is the Lost conversions case)
      THEN conversionsOpportunity x medianCartC
      ELSE IF conversionsOpportunity>0 (this is the Won conversions case)
      THEN conversionsOpportunity x medianCartS
      ELSE 0
   If conversionsOpportunity<0 then revenueOpportunity<0 and this is the Lost Revenue case.
   If conversionsOpportunity>0 then revenueOpportunity>0 and this is the Won Revenue case.
   If revenueOpportunity=0 then there was no difference or no significant difference between the 2 segments.
Revenue Opportunity Per Sessions
revenueOpportunityPerSessions=
   IF conversionsOpportunity !=0
   THEN revenueOpportunity/abs(conversionsOpportunity)
   ELSE 0

In view of the above, when looking at a value for revenueOpportunity—it is appreciated that a value for revenueOpportunityPerSessions is either equal to a value for medianCartC or medianCartS.

Thus, the revenueOpportunityPerSessions is the monetary value (e.g., in a given currency) that insights system 216 determines to be lost or won per extra sessions that were lost or won.

Examples of User Interfaces that Facilitates Reviewing Statistically Significant Insights or Errors

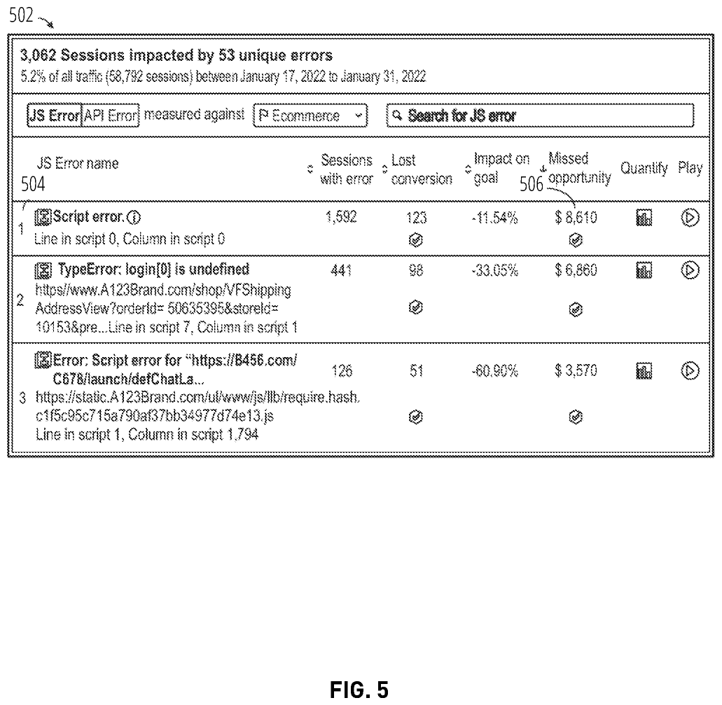

FIG. 5 is an example user interface 502 that facilitates reviewing revenue opportunities that has been determined by insights system 216 and provided for display on a client device (e.g., experience analytics client 104), in accordance with some embodiments of the subject technology. In the example of FIG. 5, different errors occurring on various webpages from a retail website can be presented for review, along with presentation of values of lost conversions, impact on a given goal (e.g., a number of conversions desired or targeted during a period of time), and missing revenue opportunities that each quantify the effects of such errors on the website.

As shown, user interface 502 includes a list of various events (e.g., errors) that each have occurred during different sessions in a particular webpage on a retail web site over a particular period of time (e.g., Jan. 17, 2022 to Jan. 31, 2022). In this example, various interface areas, including interface area 504, each represent a respective error that has occurred for a particular number of sessions, and include corresponding information related to the error such as a number of sessions, a number of lost conversion, a value indicating an impact on a goal, and a value indicating a missed opportunity 506.

As further shown, interface area 504 includes information indicating a particular error (e.g., script error related to JavaScript code on a corresponding webpage), a value indicating a number of sessions in which this error occurred, and a value indicating a number of lost conversions (as discussed above in connection with a second stage of value determined by insights system 216). In this example, interface area 504 includes a graphical item (e.g., checkmark or some other graphical representation) indicating that the value indicating the number of lost conversions is statistically significant (also as discussed before). In an implementation, if a cursor is hovered over such a graphical item, a dialog box can be presented for display with a message with information describing the statistically significance e.g., “These results are statistically significant. We are 99% confident that the session encountering the error really convert less, and that this observed conversion drop is not due to segments being too small or conversation rates being too close.”

Moreover, interface 502 includes a value indicating a percentage corresponding to an impact on a goal (e.g., conversions target, and the like), and another value indicating a monetary value for missed opportunities (e.g., in terms of revenue).

It is appreciated that user interface 502 enables identifying various errors that have occurred at the retail website and various amount of lost opportunities for revenue. By focusing on a set of errors that have lost more revenue, improvements can be prioritized for implementation which would address (or at least mitigate) such lost revenue by the errors on the retail website. Moreover, it is appreciated that resolving such errors can have technical effects thereby improving the functionality of a computer providing access to the retail website, including for example improvements in handling requests to the retail website, and at least reducing utilization of computing resources (e.g., foregoing extra CPU or network usages when errors occur as these errors do not occur after being resolved). Resolving such errors can also result in other improvements including better handling of workloads on the retail website as webpages are executing in an expected manner, leading to potentially more accurate analysis of user activity and associated metrics (e.g., insight metrics).

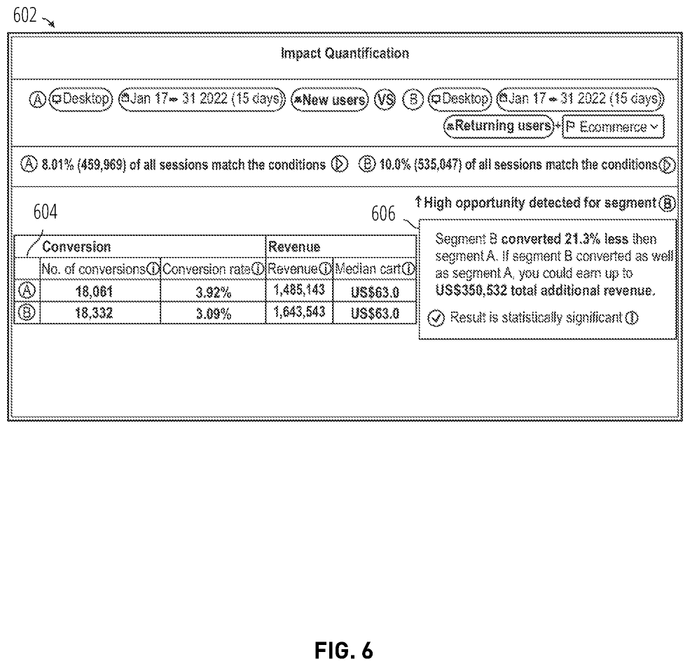

FIG. 6 is an example user interface 602 that facilitates comparing revenue opportunities between different segments of users that are provided for display on a client device (e.g., experience analytics client 104), in accordance with some embodiments of the subject technology.

In the example of FIG. 6, a first segment (“segment A”) corresponding to new users and a second segment (“segment B”) corresponding to returning users of a retail website over a period of time (e.g., 15 days from January 17 to Jan. 31, 2022) are compared, where insights system 216 determines various metrics to quantify revenue opportunity attributes for each segment based on corresponding sessions from each segment. In this example, the first segment includes 8.01% of all sessions during the period of time, and the second segment includes 10.0% of all sessions during the period of time.

As shown, user interface 602 includes interface area 604 and interface area 606. Interface area 604 includes information for the first segment A and the second segment B showing respective values for a number of conversion and a conversion rate. Additionally, interface area 604 includes information for each segment showing values for a revenue amount and a median value of a cart (e.g., median purchase amount for the sessions). In interface area 606, information is displayed indicating that the second segment converted a lesser percentage than the first segment, and that if the second segment had converted the same as the first segment then a particular value of additional revenue could have been achieved. Further, interface area 606 also indicates that the metrics are statistically significant.

### Machine Architecture

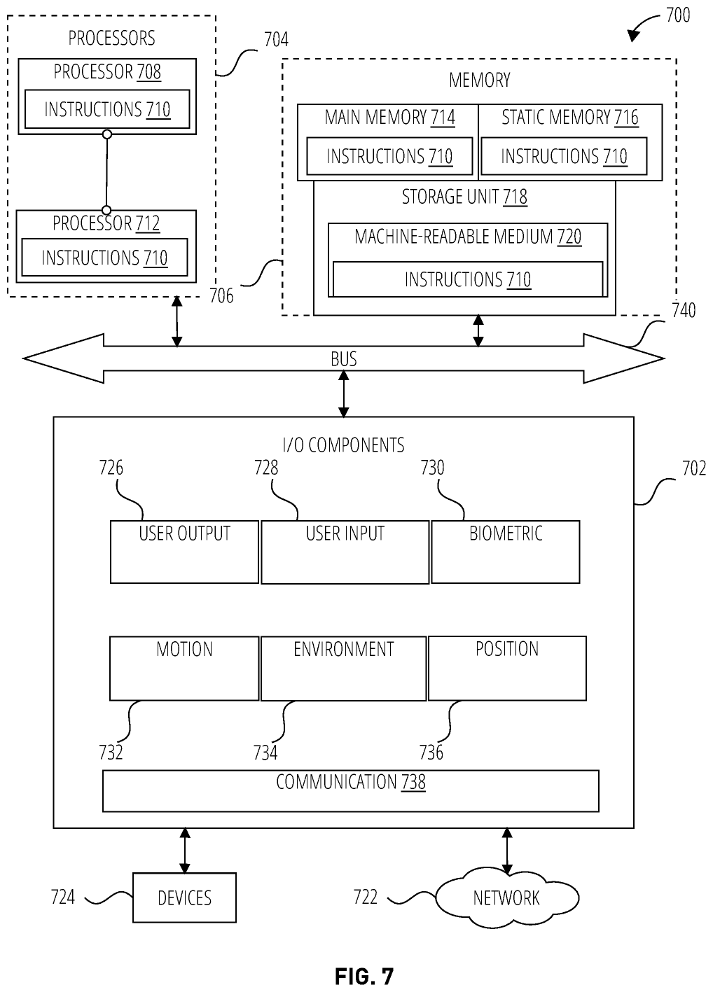

FIG. 7 is a diagrammatic representation of the machine 700 within which instructions 710 (e.g., software, a program, an application, an applet, an application, or other executable code) for causing the machine 700 to perform any one or more of the methodologies discussed herein may be executed. For example, the instructions 710 may cause the machine 700 to execute any one or more of the methods described herein. The instructions 710 transform the general, non-programmed machine 700 into a particular machine 700 programmed to carry out the described and illustrated functions in the manner described. The machine 700 may operate as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 710, sequentially or otherwise, that specify actions to be taken by the machine 700. Further, while only a single machine 700 is illustrated, the term “machine” shall also be taken to include a collection of machines that individually or jointly execute the instructions 710 to perform any one or more of the methodologies discussed herein. The machine 700, for example, may comprise the member client device 102 or any one of a number of server devices forming part of the experience analytics server 116. In some examples, the machine 700 may also comprise both client and server systems, with certain operations of a particular method or algorithm being performed on the server-side and with certain operations of the particular method or algorithm being performed on the client-side.

The machine 700 may include processors 704, memory 706, and input/output I/O components 702, which may be configured to communicate with each other via a bus 740. In an example, the processors 704 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 708 and a processor 712 that execute the instructions 710. The term “processor” is intended to include multi-core processors that may comprise two or more independent processors (sometimes referred to as “cores”) that may execute instructions contemporaneously. Although FIG. 7 shows multiple processors 704, the machine 700 may include a single processor with a single-core, a single processor with multiple cores (e.g., a multi-core processor), multiple processors with a single core, multiple processors with multiples cores, or any combination thereof.

The memory 706 includes a main memory 714, a static memory 716, and a storage unit 718, both accessible to the processors 704 via the bus 740. The main memory 706, the static memory 716, and storage unit 718 store the instructions 710 embodying any one or more of the methodologies or functions described herein. The instructions 710 may also reside, completely or partially, within the main memory 714, within the static memory 716, within machine-readable medium 720 within the storage unit 718, within at least one of the processors 704 (e.g., within the processor's cache memory), or any suitable combination thereof, during execution thereof by the machine 700.

The I/O components 702 may include a wide variety of components to receive input, provide output, produce output, transmit information, exchange information, capture measurements, and so on. The specific I/O components 702 that are included in a particular machine will depend on the type of machine. For example, portable machines such as mobile phones may include a touch input device or other such input mechanisms, while a headless server machine will likely not include such a touch input device. It will be appreciated that the I/O components 702 may include many other components that are not shown in FIG. 7. In various examples, the I/O components 702 may include user output components 726 and user input components 728. The user output components 726 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 728 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 702 may include biometric components 730, motion components 732, environmental components 734, or position components 736, among a wide array of other components. For example, the biometric components 730 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 732 include acceleration sensor components (e.g., accelerometer), gravitation sensor components, rotation sensor components (e.g., gyroscope).

The environmental components 734 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the member client device 102 may have a camera system comprising, for example, front cameras on a front surface of the member client device 102 and rear cameras on a rear surface of the member client device 102. The front cameras may, for example, be used to capture still images and video of a user of the member client device 102 (e.g., “selfies”). The rear cameras may, for example, be used to capture still images and videos in a more traditional camera mode. In addition to front and rear cameras, the member client device 102 may also include a 360° camera for capturing 360° photographs and videos.

Further, the camera system of a member client device 102 may include dual rear cameras (e.g., a primary camera as well as a depth-sensing camera), or even triple, quad or penta rear camera configurations on the front and rear sides of the member client device 102. These multiple cameras systems may include a wide camera, an ultra-wide camera, a telephoto camera, a macro camera and a depth sensor, for example.

The position components 736 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 702 further include communication components 738 operable to couple the machine 700 to a network 722 or devices 724 via respective coupling or connections. For example, the communication components 738 may include a network interface component or another suitable device to interface with the network 722. In further examples, the communication components 738 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 724 may be another machine or any of a wide variety of peripheral devices (e.g., a peripheral device coupled via a USB).

Moreover, the communication components 738 may detect identifiers or include components operable to detect identifiers. For example, the communication components 738 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 738, such as location via Internet Protocol (IP) geolocation, location via Wi-Fi® signal triangulation, location via detecting an NFC beacon signal that may indicate a particular location, and so forth.

The various memories (e.g., main memory 714, static memory 716, and memory of the processors 704) and storage unit 718 may store one or more sets of instructions and data structures (e.g., software) embodying or used by any one or more of the methodologies or functions described herein. These instructions (e.g., the instructions 710), when executed by processors 704, cause various operations to implement the disclosed examples.

The instructions 710 may be transmitted or received over the network 722, using a transmission medium, via a network interface device (e.g., a network interface component included in the communication components 738) and using any one of several well-known transfer protocols (e.g., hypertext transfer protocol (HTTP)). Similarly, the instructions 710 may be transmitted or received using a transmission medium via a coupling (e.g., a peer-to-peer coupling) to the devices 724.

### Software Architecture

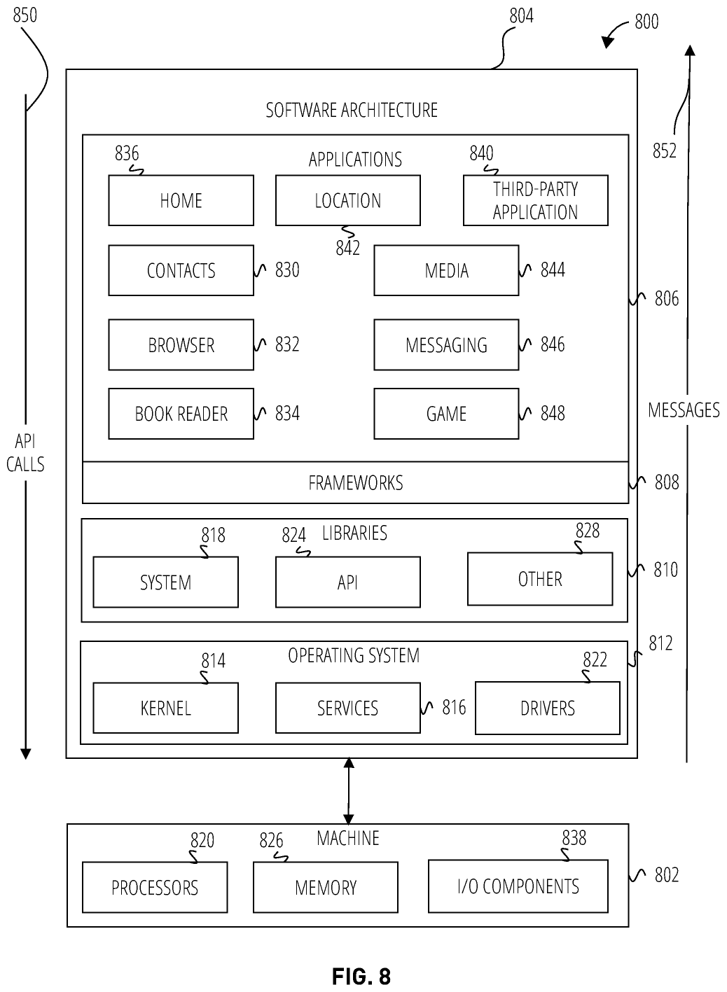

FIG. 8 is a block diagram 800 illustrating a software architecture 804, which can be installed on any one or more of the devices described herein. The software architecture 804 is supported by hardware such as a machine 802 that includes processors 820, memory 826, and I/O components 838. In this example, the software architecture 804 can be conceptualized as a stack of layers, where each layer provides a particular functionality. The software architecture 804 includes layers such as an operating system 812, libraries 810, frameworks 808, and applications 806. Operationally, the applications 806 invoke API calls 850 through the software stack and receive messages 852 in response to the API calls 850.

The operating system 812 manages hardware resources and provides common services. The operating system 812 includes, for example, a kernel 814, services 816, and drivers 822. The kernel 814 acts as an abstraction layer between the hardware and the other software layers. For example, the kernel 814 provides memory management, processor management (e.g., scheduling), component management, networking, and security settings, among other functionalities. The services 816 can provide other common services for the other software layers. The drivers 822 are responsible for controlling or interfacing with the underlying hardware. For instance, the drivers 822 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 810 provide a common low-level infrastructure used by the applications 806. The libraries 810 can include system libraries 818 (e.g., C standard library) that provide functions such as memory allocation functions, string manipulation functions, mathematic functions, and the like. In addition, the libraries 810 can include API libraries 824 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 810 can also include a wide variety of other libraries 828 to provide many other APIs to the applications 806.

The frameworks 808 provide a common high-level infrastructure that is used by the applications 806. For example, the frameworks 808 provide various graphical user interface (GUI) functions, high-level resource management, and high-level location services. The frameworks 808 can provide a broad spectrum of other APIs that can be used by the applications 806, some of which may be specific to a particular operating system or platform.

In an example, the applications 806 may include a home application 836, a contacts application 830, a browser application 832, a book reader application 834, a location application 842, a media application 844, a messaging application 846, a game application 848, and a broad assortment of other applications such as a third-party application 840. The applications 806 are programs that execute functions defined in the programs. Various programming languages can be employed to create one or more of the applications 806, structured in a variety of manners, such as object-oriented programming languages (e.g., Objective-C, Java, or C++) or procedural programming languages (e.g., C or assembly language). In a specific example, the third-party application 840 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 840 can invoke the API calls 850 provided by the operating system 812 to facilitate functionality described herein.

### Glossary

“Carrier signal” refers to any intangible medium that is capable of storing, encoding, or carrying instructions for execution by the machine, and includes digital or analog communications signals or other intangible media to facilitate communication of such instructions. Instructions may be transmitted or received over a network using a transmission medium via a network interface device.

“Client device” refers to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Ephemeral message” refers to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“Machine storage medium” refers to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers to a tangible medium that is capable of storing, encoding, or carrying the instructions for execution by a machine.

“Signal medium” refers to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

What is claimed is:

1. A method comprising:
receiving, by a processor from a plurality of client devices, user activity data associated with interactions by a plurality of users with a website displayed on the plurality of client devices, wherein the website comprises a plurality of webpages displayed during a plurality of sessions;
identifying, based on the user activity data, a plurality of errors associated with the web site;
determining a first error of the plurality of errors that is statistically significant, wherein determining the first error comprises:
determining that a number of sessions from the plurality of sessions including the first error and a number of sessions from the plurality of sessions not including the first error is greater than a minimum number of sessions threshold,
generating a test statistics value associated with the first error based on the number of sessions not including the first error, the number of sessions including the first error, an error free conversion rate that is a conversion rate of sessions not including the first error, and an error conversion rate that is a conversion rate of sessions including the first error, and
identifying the first error as being statistically significant, when the test statistic value is greater than a test statistic threshold; and
causing a user interface to be displayed on a display device, the user interface including the first error.

2. The method of claim 1, wherein each of the plurality of sessions comprises a timeframe between an entry by a user of the plurality of users into the web site and an exit by the user from the website.

3. The method of claim 1, wherein the user activity data comprises changes in an interface of the website displayed on the plurality of client devices, elements on the website displayed or visible on the interface displayed on the plurality of client devices, text inputs by the users into the website displayed on the plurality of client devices, a movement of cursor of a mouse, touchpad or touch screen, a click or activation of the mouse, the touchpad or the touch screen on the interface of the website, or any combination thereof.

4. The method of claim 1, further comprising: upon receiving an activation of a selectable item on the user interface from the display device, causing the user interface to include a visualization of interactions by the one of the users with the website during the one of the sessions associated with the first error.

5. The method of claim 4, wherein the visualization of interactions by one of the users with the website is generated based on the user activity data.

6. The method of claim 1, wherein identifying the plurality of errors associated with the website further comprises:
detecting a rage click comprising a predetermined number of repeated clicks in less than a minimum threshold of time, detecting a predetermined number of repeated interactions with an element, a field, or a button displayed on the webpages, detecting no clicks on one of the plurality of webpages displayed, detecting that a cursor is hovering more than a predetermined number of times over an element of one of the plurality of webpages, detecting an error is displayed during the session, detecting that the error is displayed after a click, detecting a loading time that exceeds a predetermined amount of time, or any combination thereof.

7. The method of claim 1, wherein the conversion rate is based a number of successful conversions on the web site, wherein the successful conversions are based on a completed purchase on the website, a completed sign-up for an account on the website, a completed application on the website, or any combination thereof.

8. A system comprising:
a processor; and
a memory storing instructions that, when executed by the processor, configure the system to perform operations comprising:
receiving, from a plurality of client devices, user activity data associated with interactions by a plurality of users with a website displayed on the plurality of client devices, wherein the website comprises a plurality of webpages displayed during a plurality of sessions;
identifying, based on the user activity data, a plurality of errors associated with the web site;
determining a first error of the plurality of errors that is statistically significant, wherein determining the first error comprises:
determining that a number of sessions from the plurality of sessions including the first error and a number of sessions from the plurality of sessions not including the first error is greater than a minimum number of sessions threshold,
generating a test statistics value associated with the first error based on the number of sessions not including the first error, the number of sessions including the first error, an error free conversion rate that is a conversion rate of sessions not including the first error, and an error conversion rate that is a conversion rate of sessions including the first error, and
identifying the first error as being statistically significant, when the test statistic value is greater than a test statistic threshold; and
causing a user interface to be displayed on a display device, the user interface including the first error.

9. The system of claim 8, wherein each of the plurality of sessions comprises a timeframe between an entry by a user of the plurality of users into the web site and an exit by the user from the website.

10. The system of claim 8, wherein the user activity data comprises changes in an interface of the website displayed on the plurality of client devices, elements on the website displayed or visible on the interface displayed on the plurality of client devices, text inputs by the users into the website displayed on the plurality of client devices, a movement of cursor of a mouse, touchpad or touch screen, a click or activation of the mouse, the touchpad or the touch screen on the interface of the website, or any combination thereof.

11. The system of claim 8, further comprising: upon receiving an activation of a selectable item on the user interface from the display device, causing the user interface to include a visualization of interactions by the one of the users with the website during the one of the sessions associated with the first error.

12. The system of claim 11, wherein the visualization of interactions by one of the users with the website is generated based on the user activity data.

13. The system of claim 8, wherein identifying the plurality of errors associated with the website further comprises:
detecting a rage click comprising a predetermined number of repeated clicks in less than a minimum threshold of time, detecting a predetermined number of repeated interactions with an element, a field, or a button displayed on the webpages, detecting no clicks on one of the plurality of webpages displayed, detecting that a cursor is hovering more than a predetermined number of times over an element of one of the plurality of webpages, detecting an error is displayed during the session, detecting that the error is displayed after a click, detecting a loading time that exceeds a predetermined amount of time, or any combination thereof.

14. The system of claim 8, wherein the conversion rate is based a number of successful conversions on the web site, wherein the successful conversions are based on a completed purchase on the website, a completed sign-up for an account on the website, a completed application on the website, or any combination thereof.

15. A non-transitory computer-readable storage medium including instructions that, when processed by a processor, configure the processor to perform operations comprising:
receiving, from a plurality of client devices, user activity data associated with interactions by a plurality of users with a website displayed on the plurality of client devices, wherein the website comprises a plurality of webpages displayed during a plurality of sessions;
identifying, based on the user activity data, a plurality of errors associated with the web site;
determining a first error of the plurality of errors that is statistically significant, wherein determining the first error comprises:
determining that a number of sessions from the plurality of sessions including the first error and a number of sessions from the plurality of sessions not including the first error is greater than a minimum number of sessions threshold,
generating a test statistics value associated with the first error based on the number of sessions not including the first error, the number of sessions including the first error, an error free conversion rate that is a conversion rate of sessions not including the first error, and an error conversion rate that is a conversion rate of sessions including the first error, and
identifying the first error as being statistically significant, when the test statistic value is greater than a test statistic threshold; and
causing a user interface to be displayed on a display device, the user interface including the first error.

16. The non-transitory computer-readable storage medium of claim 15, wherein each of the plurality of sessions comprises a timeframe between an entry by a user of the plurality of users into the website and an exit by the user from the web site.

17. The non-transitory computer-readable storage medium of claim 15, wherein the user activity data comprises changes in an interface of the website displayed on the plurality of client devices, elements on the website displayed or visible on the interface displayed on the plurality of client devices, text inputs by the users into the website displayed on the plurality of client devices, a movement of cursor of a mouse, touchpad or touch screen, a click or activation of the mouse, the touchpad or the touch screen on the interface of the website, or any combination thereof.

18. The non-transitory computer-readable storage medium of claim 15, wherein the processor to perform operations further comprising:
upon receiving an activation of a selectable item on the user interface from the display device, causing the user interface to include a visualization of interactions by the one of the users with the website during the one of the sessions associated with the first error, wherein the visualization of interactions by one of the users with the website is generated based on the user activity data.

19. The non-transitory computer-readable storage medium of claim 15, wherein identifying the plurality of errors associated with the website further comprises:
detecting a rage click comprising a predetermined number of repeated clicks in less than a minimum threshold of time, detecting a predetermined number of repeated interactions with an element, a field, or a button displayed on the webpages, detecting no clicks on one of the plurality of webpages displayed, detecting that a cursor is hovering more than a predetermined number of times over an element of one of the plurality of webpages, detecting an error is displayed during the session, detecting that the error is displayed after a click, detecting a loading time that exceeds a predetermined amount of time, or any combination thereof.

20. The non-transitory computer-readable storage medium of claim 15, wherein the conversion rate is based a number of successful conversions on the website, wherein the successful conversions are based on a completed purchase on the website, a completed sign-up for an account on the website, a completed application on the website, or any combination thereof.
